(19) United States
(12) Patent Application Publication
(10) Pub. No.: US 2006/0242001 A1
(43) Pub. Date: Oct. 26, 2006

(54) Method for assembling and assessing events for extracting structured picture of anticipated future events

(76) Inventor: Donald Heathfield, Cambridge, MA (US)

Correspondence Address: Donald Heathfield, 111 TROWBRIDGE ST., UNIT 9, Cambridge, MA, 02138, US

(21) Appl. No.: 11/405,192

(22) Filed: Apr. 17, 2006

Related U.S. Application Data
(60) Provisional application No. 60/673,061, filed on Apr. 20, 2005.

(51) Int. Cl. G07G 1/00

(52) U.S. Cl. 705/10

(57) ABSTRACT

Disclosed is a method of mapping structured anticipated future events in a domain. The method comprises: assembling an event field to comprise a depository of events related to the domain, assessing the events from the event field to formulate at least one subset having high probability anticipated future events, and extracting structured anticipated future events from at least one of the subsets, thereby projecting a picture of future for the domain. The method of the present invention helps in enhancing the ability of organizations to prepare for the future, aids decision makers to create internal processes of anticipating the risks and challenges that await the organizations, and develop strategies to deal with the risks and challenges proactively. By utilizing the methodologies of the present invention, organizations can drive the learning process, to help them to prepare for the future.

### CROSS REFERENCE TO RELATED APPLICATION

This patent application is related to the U.S. patent application Ser. No. ______ dated ______ and assigned to the assignee of the present invention.

### FIELD OF THE INVENTION

The present invention relates to a method for assembling, and assessing events for extracting structured picture of anticipated future events.

### BACKGROUND OF THE INVENTION

Executives of the top management in the present corporate environment are under tremendous pressure to make their companies more reactive, competitive and resilient. The challenges faced by the organizations include increasing uncertainty and rapid changes in the external environment, on which, the organizations do not have any control. As such, the executives and the corporate leaders recognize that preparing their businesses for the future is one of their main priorities, since being well positioned to react to surprises (incidents) when they occur is much better than merely being surprised when an incident occur.

The internal complexity of global enterprises does not facilitate fast and coherent responses to strategic challenges. Most of the global enterprises in the present era do not have a sound future preparedness system to enable them to deal with risks associated with the enterprise's long term strategy.

Some of the challenges faced by organizations while preparing for the future include assembling a coherent picture of the future from a multitude of facts and opinions, presenting the future in a way that facilitates decision making, involving the maximum of people into scanning of the global environment, integrating and sharing information of different types from different sources, learning continuously to question assumptions and conclusions about the organization, making the information collection and assessment processes to work together as one, driving shared awareness of the future, control the progress towards future objectives in a better manner, building a future preparedness system for the organization. Organizations need to recognize the above challenges early and make appropriate timely decisions to improve their ability to react to uncertainties, and risks of the future. The responsibility of future challenges in business usually lies with personnel responsible for formulating corporate strategy, corporate foresight, and corporate intelligence. The personnel responsible for such decision making need to have a continuously updated structured picture of the anticipated future events to enable them to prepare strategies for future challenges faced by the organization. Such pictures of anticipated future event need to be readily available to the business leaders to help them deal with the future events more efficiently.

While some organizations have built global communities that include representatives of planning, intelligence and other functions, the vast majority of businesses do not have effective systems for creating and sharing a common picture of the future. Organizations need a common repository of information and a shared space for dialogue about the future. To enable discussion, the organizations also need to present the picture of future challenges in a clear and compelling way. While many foresight and scenario projects pursue the exploration of long-term strategic alternatives, the majority of organizations decisions focus on a much shorter time horizon—from a few months to 3-5 years. As a result, such foresight projects catch decision-makers' attention too infrequently to create a permanent working engagement.

Attempts have been made in the past to address the issue of future preparedness by developing various methodologies. Some “Early Warning” systems have been developed to stress upon importance of good environmental scanning, however, such systems have failed to earn sufficient long-term management commitment. This can be attributed to companies fail to establish the right relationships and balance between tactical market intelligence activities usually conducted by Business Units and the Sales and Marketing organizations and the strategic intelligence work that focuses on ensuring the long-term competitive health of the enterprise. Another problem connected with the same may be the imbalance between the producers of foresight and its potential users.

Other approaches like the ‘Balanced Scorecard’ and ‘Strategy Map’ have been adopted by many businesses. These approaches aim at measuring organizations performance from four major perspectives: financial, customer, internal process, and learning and growth,” and “creating a common visual framework that embeds the items on the balanced scorecard into a cause-and-effect chain. The Balanced Scorecard and a Strategy Map helps organizations to define and communicate their objectives and strategies in a cohesive, integrated and systematic way. However, these methodologies do not provide any process for looking at how the changes in business environment affect the validity and effectiveness of such methodologies.

While specific methods and traditions of exploring the future differ from enterprise to enterprise, scenario development, usually integrating many other methodologies at its earlier stages, plays a critical role in the majority of future exploration efforts.

As such, the existing methodologies do not systematically deal with the ways to populate the future space i.e. systematically translating all available information about the future into anticipated events. Further the, existing methodologies do not provide for creating the picture of the future that can be analyzed, tracked and debated, and the same may be attributed to the disconnect between strategy development and resource allocation processes, and, broadly, the inability of many traditional management systems to link long-term and short-term perspectives. In most of the existing methodologies, the mapping was done by either creating milestones to future scenarios (by scenario consultants) or as projection of trend lines (economics, science). All such processes were done without creating the structured future space (so the information could not be saved or analyzed), so, the results were difficult to compare. Further, no specific support software is available to assist organizations in creating a structured future space.

Accordingly, what is needed is an approach to build a comprehensive strategic future management system for providing a structured picture of the future in which all information about anticipated future events is organized.

### SUMMARY OF THE INVENTION

In view of the foregoing disadvantages inherent in the prior arts, the general purpose of the present invention is to provide a method, and computer program for mapping future events and to include all the advantages of the prior art, and to overcome the drawbacks inherent therein.

In one aspect, the present invention provides a method of mapping structured anticipated future events in a domain. The method comprises: assembling an event field to comprise a depository of events related to the domain, assessing the events from the event field to formulate at least one subset having high probability anticipated future events, and extracting structured anticipated future events from at least one of the subsets, thereby projecting a picture of future for the domain.

In another aspect, the present invention provides a method for assembling an event field of a domain. The method comprises: selecting the domain; defining a plurality of factors impacting the domain; defining key repeating events for each factor in the domain; defining predecessor event and follower event for each the key repeating event; adding a first subset of anticipated future events occurring at known regular intervals in the event field; adding a second subset of anticipated future events in the event field by applying trends and projections on each of the factor; adding a third subset of anticipated future events in the event field based on predictions of developments by human experts; adding a fourth subset of anticipated future events in the event field based on anticipated disruptions in trends and wild cards; adding events in the event field for a current day; and adding past events in the event field based on the importance of the past events in the domain.

In yet another aspect, the present invention provides method for assessing an event field of a domain. The method comprises examining the event field to identify irrelevant events in the event field, and eliminating the irrelevant events from the event field; reviewing impact of recent events on anticipated future events in the event field; identifying key anticipated future events in the event field; defining and identifying leading indicators for the key anticipated future events for tracking and setting milestone events; evaluating probabilities for the key anticipated future events; assessing impact of the key anticipated future events on the domain, and identifying risks and challenges associated with the key anticipated future events; reviewing the event field for projecting strategy options and anticipating decisions in the domain; and extracting structured anticipated future events from the event field.

These together with other aspects of the present invention, along with the various features of novelty that characterize the invention, are pointed out with particularity in the claims annexed hereto and forming a part of this disclosure. For a better understanding of the invention, its operating advantages and the specific objects attained by its uses, reference should be had to the accompanying drawings and descriptive matter in which there are illustrated exemplary embodiments of the present invention.

### BRIEF DESCRIPTION OF THE DRAWINGS

The advantages and features of the present invention will become better understood with reference to the following more detailed description and claims taken in conjunction with the accompanying drawings, wherein like elements are identified with like symbols, and in which:

FIG. 1 is a framework illustrating an event field 100 of a domain, according to an exemplary embodiment of the present invention;

FIG. 2 illustrates a two dimensional spreadsheet software screen having the event field 100 assembled therein, according to an exemplary embodiment of the present invention;

FIG. 3 is a flowchart illustrating the steps involved in event field assembly 200, according to an exemplary embodiment of the present invention; and

FIG. 4 is a flowchart illustrating the steps involved in event field assessment 300, according to an exemplary embodiment of the present invention;

Like reference numerals refer to like parts throughout the description of several views of the drawings.

### DETAILED DESCRIPTION OF THE INVENTION

The exemplary embodiments described herein detail for illustrative purposes are subject to many variations in methodologies and design modules. It should be emphasized, however, that the present invention is not limited to a particular method for assembling and assessing events for extracting structured picture of anticipated future events, as shown and described. Rather, the principles of the present invention may be used with a variety of methodologies and design modules for providing simplicity in assembling and assessing occurred events and extracting anticipating future events. It is understood that various omissions, substitutions of equivalents are contemplated as circumstances may suggest or render expedient, but is intended to cover the application or implementation without departing from the spirit or scope of the claims of the present invention.

The terms “first,” “second,” and the like, herein do not denote any order, quantity, or importance, but rather are used to distinguish one element from another, and the terms “a” and “an” herein do not denote a limitation of quantity, but rather denote the presence of at least one of the referenced item.

The present invention provides a method for mapping structured anticipated future events. The present invention addresses the problem of creating a structured space (time-factors) in which all information about anticipated future events are organized. The present invention provides for a creation of a structured picture of the future from the events, by the contributions from human experts. The present invention creates a permanent process of reevaluation and reassessment of future events, by continuously updating the structured picture of the future events based on the updated information. The method of the present invention helps in enhancing the ability of organizations to prepare for the future. The present invention aids decision makers to create internal processes of anticipating the risks and challenges that await the organizations, and develop strategies to deal with the risks and challenges proactively. By utilizing the methodologies of the present invention, organizations can drive the learning process, to help them to prepare for the future.

The present invention further provides a way of organizing and presenting decision-oriented information about the future, a way of synthesizing cross-time and cross-domain knowledge about the future, a way of continuously integrating and managing global and internal knowledge about the future, and a way of creating a permanent link between strategy, intelligence and learning.

The methodologies of present invention can be utilized by personnel responsible for strategy, planning and intelligence in governments (for example, State Departments, National Intelligence Council; Office of Conflict Monitoring and Prevention), corporate sectors (for example, planning, strategy, and IT strategy departments of corporate sectors), non-profit organizations, and other organizations dealing with building a global community around an important future issue.

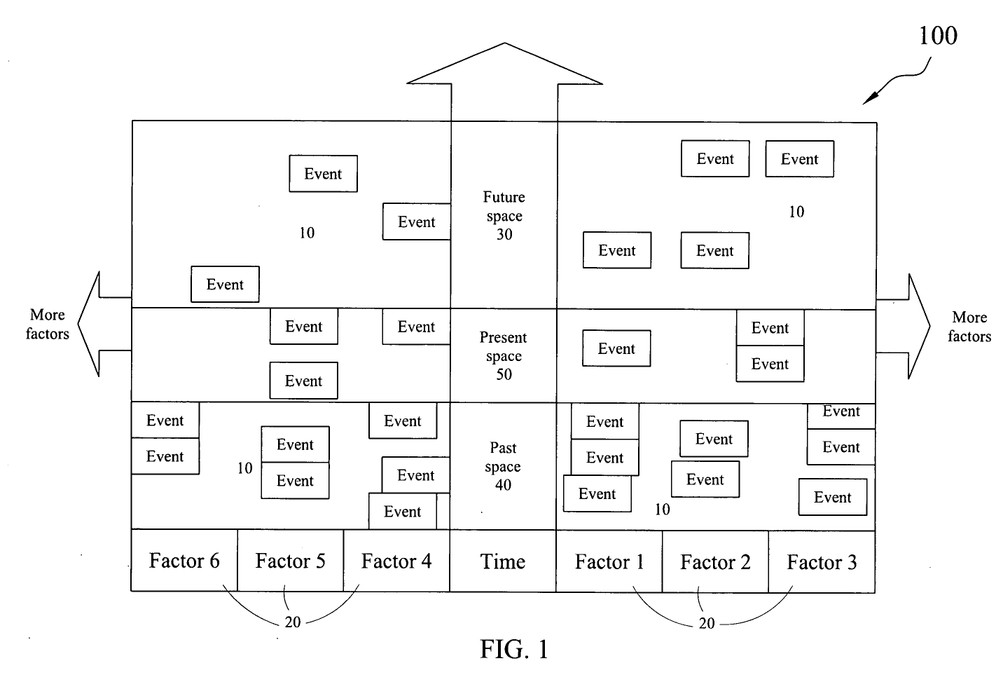

Referring to FIG. 1, a framework is shown, illustrating an event field 100 of a domain. The domain (for example, US congress, Singapore, Defense Department) may be a geographical or topical area, for which the future events are being mapped. The event field 100 comprises a plurality of events 10 related to the domain. The event 10 may be an occurrence, an activity or happening in the domain (who did (or will do) what to/with Whom, When and Why). The event 10 may be an occurred event or a future event. Individuals' involved in the domain may define the significance of events, and decide, whether such events need to be included as events 10 in the event field 100. For example, a state of environment that is the domain, such as [symbol] 1=$1.19, as on Feb. 27, 2007, can be represented as an event 10 (future event) and the visit of the President of US to India in the month of March 2006 may also be an event 10 (occurred event). The events 10 in the domain may be affected by an internal or external force, called as factors 20. The factor 20 may be an internal factor (internal force within the domain), or an external factor (external force outside the domain). Considering a domain ‘Foreign Affairs’ of the US, the event 10 may be the visit of President of US to India in the month of March 2006. The political situation, the economical situation and the like within US may be considered as the internal factors effecting the event 10 of the domain ‘Foreign Affairs’ and the external factors may be the US-Pakistan relationship, political situation in the South East Asia and the like.

The events 10 in the event field 100 are arranged in a two-dimensional space (for example, computer screen or paper). The events 10 are organized in a first dimension based on the time of their occurrence, from past to future. The events 10 are organized in a second dimension based on the relationship of the events 10 with the factors 20 (internal factors or external factors). A third dimension of the event field 100 may be constituted by the implications (consequences, or anticipated consequences) of each event 10. The third dimension may also be expressed in occurred events or anticipated future events. A future space 30 in the event field 100 of the domain corresponds to anticipated future events, a past space 40 corresponds to events occurred in the past, and a present space 50 corresponds to events occurring at the present time (See FIG. 1). Depending on the needs of the decisions makers and the availability of information, density of an event field is defined, in terms of time increments (such as intervals like, seconds, minutes, hours, days, weeks, months, a year and the like). Individual events or a combination of a plurality of events may constitute a subset of an event field. One or more such subsets may be extracted from the event field of the domain for preparing a future map having the anticipated future events impacting the domain. Such extracted future maps may be used for requirements of strategy building, planning, intelligence presentations and the like.

Event field can be assembled in a space, or a computer screen, called as assembly screen. Assembly screen comprises all events that are put into the event field, without discrimination and represents the depository of events. Assembly screen may serve as a common interaction and collaboration tool for the expert community collectively working on mapping, and assessing anticipated future events of the domain. The version of the assembly screen that contains all events but has not yet been analyzed and adjusted (treated) by experts to eliminate mistakes and inconsistencies may be called raw assembly screen. Various types of presentation screens can be derived from the assembly screen to fit specific purposes, levels of complexity and details of customer needs. For example, a basic presentation screen display may have internal factors arranged to the right, and external factors arranged on the left; in a single scenario screen, events on a screen represent one particular scenario of the domain's future; in multiple scenario screen, events are grouped and presented in each category or column of factor, to reflect several possible future scenarios for the domain; single factor screens may represent multiple scenarios in a single factor or category; expert and source screens may represent events that have been extracted by one specific human expert (or a group of human experts) or one specific source (example: Chinese experts, Strategic Forecasting Inc.); tracking screen is a screen used for tracking how actual events fit into specific scenario which is represented by multiple milestones set at various times in the future; “Chain of events” screens shows events that are dependent on each other according to input coding or other such logic.

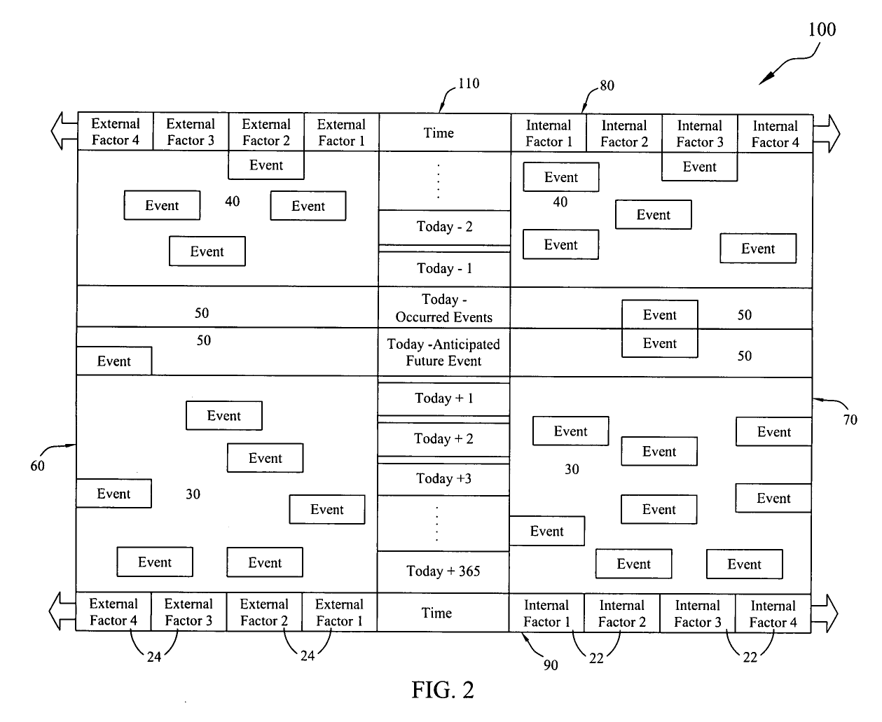

As shown in FIG. 2, the events 10 in the event field 100 may be organized in a two dimensional spreadsheet software screen. The two dimensional spreadsheet software screen comprises a left margin 60, a right margin 70, a top margin 80, and a bottom margin 90. The left margin 60, the right margin70, the top margin 80, and the bottom margin 90 define a plurality of field constituting rows, and columns. Of the plurality of columns between the left margin 60 and the right margin 70, a central column 110 comprises increments of time (such as day, week, month, quarter, years, , or in any other similar order) organized in a manner, such that, the present space 50 having time increments corresponding to present events is arranged in the middle of the central column 110 (the present space 50 is distributed in two parts having time increments corresponding to the present day's occurred events and the present day's anticipated future events); the future space 30 having time increments corresponding to future events below the present space 50 towards the bottom margin 90; the past space 40 having time increments corresponding to past events arranged in the central column 110 above the present space 50 towards the top margin 80. For example, if the event field 100 of a domain has been defined for the month of April 2006, then, the central column is organized such that the days are incremented, with. April 1 at the top field of the central column 110, and April 30 at the bottom field of the central column 110. The row along the bottom margin 90 of the two dimensional spreadsheet software screen comprises internal factors 22, and external factors 24 organized in a manner, such that, the internal factors 22 are organized to the right of the central column 110 towards the right margin 70 and the external factors 24 are organized to the left of the central column 110 towards the left margin 60. (For example, if the domain is China, then one internal factor may be state-owned enterprises, and one external factor may be US trade policy with China).

Events 10 are arranged in the two dimensional spreadsheet software screen based on the occurrence of the event 10 at a particular time, and its relationship with one or more factors 20. The events 10 are arranged in a field at the intersection of time and factors 20 (internal 22 or external 24). If the event 10 refers to several factors at the same time, such events 10 may be put on the event field 100 in several fields. Each factor 20 may occupy a number of columns on the screen to accommodate a large number of related events that may appear in a given time period. Each event 10 may have a reference number defining the source, date, type, relationships with other events 10, number of places the event 10 is appearing, and the like. Events 10 may be abbreviated in the software screen, and full text of events 10 may be extracted from the source. Also, reference number of events 10 may be obtained by right-clicking the event 10 in the software screen. In addition, events 10 may be coded to indicate the relationship of one event 10 with the other event 10 or leading indicators or followers of other events 10 or events 10 that usually happen together. Such coding allows the extraction of a chain of related events 10 from an event field 100. Furthermore, coding allows a systematic analysis of chain of events 10 (actual events and anticipated future events) to help in modeling and simulations.

Mapping structured anticipated future events includes the process of assembling the event field, hereinafter referred to as event field assembly 200 and assessing the event field, hereinafter referred to as event field assessment 300. Event field assembly 200 is a multi-step process of inputting current events as well as anticipated future events from various sources into the assembly screen, thereby, assembling a structured picture of the future from a multitude of facts and opinions to present the future in a way that facilitates decision making. Events 10 may originate from two main types of sources: human experts and automatic information extraction tools. Events 10 may also originate from knowledge, trend projection, newswire, and the like. Events 10 in the event field 100 may be clearly identified by the source, and also by the level of reliability of the source. Events 10 that are planned and scheduled need to be distinguished from those events 10 that human experts simply expect to occur due to the logic of observed developments in the domain. Event field assembly 200 for a domain includes, organizing the anticipated future events in the event field 100, reviewing the events 10 that are already included, and adjusting the events 10 based on the updated information. The picture of anticipated future (especially immediate future) in the domain achieves greater precision and depth with each iteration of steps included in the event field assembly 200. Event field assessment 300 is a continuous process performed by human experts responsible for mapping, and assessing anticipated future events of the domain. The event field assembly 300 comprises reviewing and analyzing the events field 100 of the domain, identifying trends and scenarios, evaluating probabilities of key events, and preparation of various presentation screens. The picture of anticipated future (especially immediate future) in the domain achieves greater precision and depth with each iteration of steps included in the event field assessment 300.

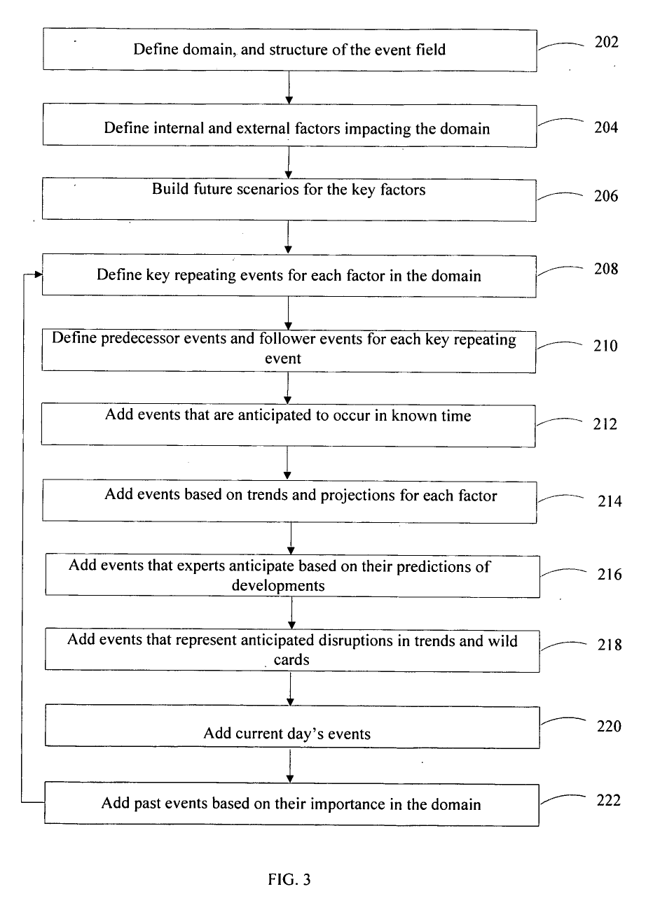

Referring now to FIG. 3, a flowchart illustrating the steps involved in the event field assembly 200 is shown. At step 202, the method starts with defining a domain, and structure of the assembly screen for the event field 100 of the domain. The domain may include an enterprise, or a country for which the future map is being prepared (i.e. China, Iraq, US Congress, Boston, Nuclear Industry etc.). At step 204, factors of the domain are defined. The step 204 involves defining internal and external factors impacting the domain, grouping the factors into categories (if necessary), arranging the factors (or categories) by importance of their impact on the domain. For example, in an embodiment, the factors may be arranged from right to left in columns of the assembly screen, with more important factors closer to the central column of the event field. The frequency of keywords being mentioned together in various sources may help determine the relative importance of a factor for a domain. For example, the keyword ‘communist party’ can be often associated with the domain ‘China’, and, accordingly, ‘communist party’ can be an important factor affecting the events of the domain ‘China’.

At step 206, future scenarios are built for the key factors, including setting milestones for scenarios of the key factors. At Step 208, key repeating events for each factor in the domain is defined. Corresponding to each factor in the event field, anticipated future events are defined that usually follow known repeating patterns and form a framework. For example, if ‘China’ is defined as the domain, and ‘Communist Party’ is defined as the factor, then a key repeating event for the factor can be ‘Party Congress every four years’. Defining key repeating events can be accomplished by a group of human experts, or by identifying a set of repeating events, or by using search software to input known patterns of events in the domain. The results of software based searches may be checked for consistency by human experts. Human Experts may input alternative dates for the key repeating events if it is anticipated that there is a change in event patterns in the future.

At step 210, for each key repeating event, the predecessor events and follower events are identified and inputted in the event field. Based on the best available knowledge, human experts can identify and input predecessor and follower events for the key repeating events that relate to each factor. (Example: China—Communist Party—Politburo Meeting and Standing Committee of the Military Commission Meeting before the Congress).

At Step 212, anticipated future events (scheduled future events) with known times are input in the event field i.e. events that are anticipated to occur in a known time in the future are collected and assembled. Such scheduled future events may be obtained from human experts of the domain, or by scanning all available information sources such as web, newswire reports, and the like, to gather information pertaining to events with known dates related to the factors of the domain. The above process of gathering information from information sources and human experts may be done continuously and information about anticipated future events for multiple domains can be collected in the process (For example, a source with knowledge of situation in China anticipates that changes in the way the government finances State Owned Enterprises, will take place at a specific date).

At Step 214, events are added based on the trends and projections for each factor. Trends and projections may be applied to factors in the domain using additional columns beside the factor columns as necessary in the event field. Separate columns may be created to fill in short and long term trends. Economic, social, demographical, geopolitical and other trends may be expressed in events. Economic data such as exchange rates, growth rates, and the like, may be input from the forecasts directly. (For example: value of dollar to RMB on specific date as an event (Jun. 14, 2007—$1=8.26 RMB, rate of growth in China—8.3%, etc.). Geopolitical and other trends can be expressed as a description of a situation anticipated at a specific date according to trends. For each trend, there might be several scenarios. Such alternatives can be represented in side-by-side columns, and may be numbered and named to be ready for assessment and comparison.

At Step 216, events that human experts anticipate based on their predictions of development are added. Human experts may add events that are likely to take place considering the knowledge human experts have on the domain and the information already assembled in the event field. Events anticipated by human experts may represent the consequences of the events in the event field, events that are required to happen before an already scheduled event takes place, events that are bound to happen together (in parallel) with a high probability anticipated event.

At step 218, events that represent anticipated disruptions in trends and wild cards are added. Human experts may identify key disruptions in trends and wild card events that may occur and affect the domain, and include those events in the event field at the appropriate columns of the respective factor. Alternatively, each anticipated disruption can occupy a separate column in the event field to allow better tracing of events associated with this disruption.

At Step 220, current day's events are added. Both human experts and automatic extraction tools may be used to engage in this daily operation.

At step 222, past events are added based on their importance in the domain. Human experts may include past events that they believe need to be taken into consideration in the development of the event field. The process of adding past events can be done continuously to allow better tracking of the future developments. The step 208 through to step 222 is continuously repeated at regular intervals to add greater precision, and depth in the event field of the domain.

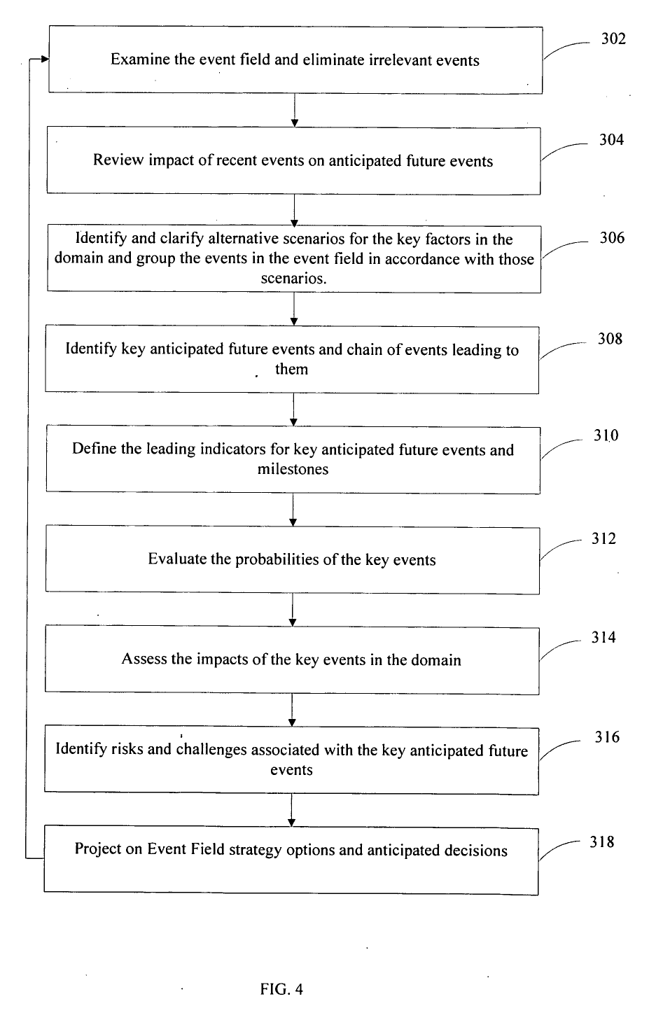

FIG. 4 is a flowchart illustrating the steps involved in event field assessment 300. At step 302, the event field (events gathered during event field assembly) is examined and irrelevant events are eliminated. The event field of the domain is examined by human experts to identify and correct mistakes and inconsistencies, and also makes sure that the events put into the event field by automatic extraction tools correctly relate to the factors. Human experts identify areas where trends appear not to match with the events anticipated by human experts or automatic extraction tools for further examination. Human experts also identify disagreements and conflicts between information gathered from various sources and anticipations of various groups of human experts. At step 304, human experts review impact of recent events on anticipated future events. At step 306, human experts identify and clarify alternative scenarios for the key factors in the domain and group the events in the event field in accordance with those scenarios. Furthermore, human experts set milestones that would help tracking the developments related to specific scenarios. Separate columns may be created in the event field for such tracking. At step 308, human experts identify key anticipated future events (by conducting expert polls) in the event field that greatly affect the future directions of the developments in the domain. Also, a chain of events leading to the key future events is identified. Tools such as collaboration software may assist human experts to work on the assessment of individual events in the event field by clicking on a particular event. Human experts may also assign level of importance to events, add comments about events, and expected impacts and connections to other events. Furthermore, human experts may estimate probabilities of key events, sets of events or entire scenarios on the event field using decision markets techniques. At step 310, human experts define and identify the leading indicators for key anticipated future events to track and set up milestone events that help in tracking the developments in the key anticipated future events. At step 312, the probabilities of the key events are evaluated. At step 314, human experts assess the impacts of the key events in the domain. For example, by using collaboration software, human experts may right-click on events to enter their assessment of the event's impact on other events and factors in the domain. At step 316, human experts identify risks and challenges associated with the key anticipated future events. At step 318, human experts review the event field to project on strategy options, and anticipated decisions. The aforementioned steps are repeated at regular intervals, such that, the picture of anticipated future in the domain achieves greater precision and depth.

A structured, easily readable subset of anticipated future events in the domain may be extracted from the process of event field assembly 200 and event field assessment 300, to constitute the future map (or a set of future maps) of the domain. Several future maps having easily readable subset of anticipated future events can be extracted from the event field, depending on the need and scope of the domain. Each extracted future map may convey a particular scenario, a vision of a particular group of human experts, an extract from a specific type of sources, or a picture with a specific time horizon. The future map extracted thereby may be updated and extracted daily to reflect the latest information and analysis.

The future map serves as a unique repository of all information about the future of an organization by providing decision makers instant view of anticipated future events and challenges. The extracted future map comprising the anticipated future events in the domain may also serve as an integration tool, a learning tool, a strategy development tool, a planning tool, and progress tracking tool for decision-makers. The future map bridges the gap between short-term trend extrapolations and long-term scenarios, helping decision-makers better understand the time horizon within which the majority of policy decisions need to taken to produce better results. By offering the capacity to show a variety of visions of the future, the future map helps in evaluating scenarios, reconciling conflicting information, understanding alternative perspectives, identifying discontinuities and examining gaps in knowledge. By focusing on future milestones, the future map forces decision makers to actively search for early indicators of emerging trends. By assessing the impacts of events across time and across domains, the future map encourages holistic thinking about the future, promotes more systematic and rigorous analysis of risks and challenges and fosters discussions among all contributors. The future map further facilitates the assessment of probabilities and expected impacts of the events in the domain by providing “decision market” technologies (“prediction market technologies”) with structured sets of events. The future map also enhances early warning systems for corporate by linking strategy, intelligence and learning, and connecting collection and assessment processes. The future map further puts corporate objectives and strategies on the timeline and within the context of the changing external and internal factors.

The future map constituted by the structured anticipated future events may act as a framework for setting organizational objectives and strategic milestones in relation to the organization's internal factors and external factors, and then tracking the organization's progress towards the objectives. The milestones assembled in the event field may help the organization to track the progress in achieving the objectives as well as external factors affecting the performance, such as, the organization's regulatory and competitive environment. The events affecting the future of an organization's customer may also be extracted from the event field, to help decision makers formulate or adjust the marketing strategy of the organization. Further, the future map may include information obtained during competitive and market intelligence research from Business Units, R&D centers, or external consultants. The future map having structured information of high probability anticipated future events enable decision-makers in the organization to better understand the information, that is needed to make decisions, to formulate and adjust the objectives of the organization.

In one embodiment, the future map may be extracted, and built using programmable instructions forming a software product. The software product may provide appropriate visualization, collaboration tools, automatic search, and extraction tools. The software product may facilitate the creation of a global expert community in an organization (or domain), thereby expanding the organization's capacity to foresee, and to meet future challenges.

Various embodiments may further include receiving, sending or storing instructions and or/data that implement the functionality of assembling, and assessing events for extracting high probability anticipated future events thereby formulating a structured picture of the future, in accordance with the present invention, upon a computer readable medium. Such a computer readable medium may include but is not limited to a storage media or memory media such as magnetic media (e.g., floppy disks), optical media (e.g., disk or CD-ROM), volatile or non volatile media such as Random Access Memory (RAM), Read Only Memory (ROM), and the like, as well as transmission media or signals such as electrical, electromagnetic, or digital signals, conveyed via a communication means such as network and/or wireless link, wherein, when a computer program code, implementing the embodiments of the present invention, is loaded onto and executed by a computer, the computer becomes an apparatus for practicing the present invention. When implemented on a general-purpose microprocessor, the computer program code segments configure the microprocessor to create specific logic circuits.

The foregoing descriptions of specific embodiments of the present invention have been presented for purposes of illustration and description. They are not intended to be exhaustive or to limit the invention to the precise forms disclosed, and obviously, many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is understood that various omissions, substitutions of equivalents are contemplated as circumstance may suggest or render expedient, but is intended to cover the application or implementation without departing from the spirit or scope of the claims of the present invention.

What is claimed is:

1. A method of mapping structured anticipated future events in a domain, comprising:
assembling an event field to comprise a depository of events related to said domain;
assessing said events from said event field to formulate at least one subset having high probability anticipated future events; and
extracting structured anticipated future events from at least one of said subsets, thereby projecting a picture of future for said domain.

2. The method of claim 1, wherein said event field comprises a past space, present space, and a future space for arranging said events.

3. The method of claim 2, wherein said past space has time increments corresponding to occurred events, said present space has time increments corresponding to occurring events and said future space has time increments corresponding to anticipated future events.

4. The method of claim 1, wherein said event field comprises a plurality of factors impacting said domain.

5. The method of claim 4, wherein said factors include internal factors and external factors.

6. The method of claim 1, wherein said event field is assembled in a paper.

7. The method of claim 1, wherein said event field is assembled in a computer screen.

8. The method of claim 1, wherein said events are collected through a plurality of sources selected from the group consisting of web, automatic extraction tools, search tools, newswire reports, trend projections, and human experts.

9. A method for assembling an event field of a domain, comprising:
(a) selecting said domain;
(b) defining a plurality of factors impacting said domain;
(c) defining key repeating events for each factor in said domain;
(d) defining predecessor event and follower event for each said key repeating event;
(e) adding a first subset of anticipated future events occurring at known regular intervals in said event field;
(f) adding a second subset of anticipated future events in said event field by applying trends and projections on each said factor;
(g) adding a third subset of anticipated future events in said event field based on predictions of developments by human experts;
(h) adding a fourth subset of anticipated future events in said event field based on anticipated disruptions in trends and wild cards;
(i) adding events in said event field for a current day; and
(j) adding past events in said event field based on the importance of said past events in said domain.

10. The method of claim 9, further comprising repeating steps (c) to (j) at regular intervals for collating a plurality of events in said event field.

11. The method of claim 9, further comprising building future scenarios for at least one of said factors having significant impact on said domain.

12. The method of claim 9, wherein said events are collected through a plurality of sources selected from the group consisting of web, automatic extraction tools, search tools, newswire reports, trend projections, and human experts.

13. The method of claim 9, wherein said event are assembled in an assembly screen, the assembly comprises:
a left margin;
a right margin;
a top margin;
a bottom margin;
a plurality of rows defined between said top margin and said bottom margin, one of said rows having internal factors and external factors; and
a plurality of columns defined between said left margin and said right margin, such that an intersection of said rows and columns configuring a plurality of fields, one of said columns having a past space, a present space, and a future space.

14. The method of claim 13, wherein said past space has time increments corresponding to occurred events, said present space has time increments corresponding to occurring events and said future space has time increments corresponding to anticipated future events.

15. The method of claim 9, wherein said event field is assembled in a paper.

16. The method of claim 9, wherein said event field is assembled in a computer screen.

17. A method for assessing an event field of a domain, comprising:
(a) examining said event field to identify irrelevant events in said event field, and eliminating said irrelevant events from said event field;
(b) reviewing impact of recent events on anticipated future events in said event field;
(c) identifying key anticipated future events in said event field;
(d) defining and identifying leading indicators for said key anticipated future events for tracking and setting milestone events;
(e) evaluating probabilities for said key anticipated future events;
(f) assessing impact of said key anticipated future events on said domain, and identifying risks and challenges associated with said key anticipated future events;
(g) reviewing said event field for projecting strategy options and anticipating decisions in said domain; and
(h) extracting structured anticipated future events from said event field.

18. The method of claim 17, further comprising repeating steps (a) to (h) at regular intervals for improving precision of said anticipated future events.

19. The method of claim 17 further comprising reviewing scenarios of factors impacting said domain, identifying alternative scenarios for significant factors in said domain, and grouping events in said event field based on said alternative scenarios;
